(19) United States
(12) Patent Application Publication
(10) Pub. No.: US 2024/0403389 A1
(43) Pub. Date: Dec. 5, 2024

(54) RANDOM SAMPLING-BASED COLLECTIVE CLASSIFICATION METHOD AND SYSTEM FOR SYBIL ACCOUNT DETECTION

(71) Applicant: Korea Advanced Institute Of Science And Technology, Daejeon (KR)

(72) Inventors: Sooel SON, Daejeon (KR); Dongwon SHIN, Daejeon (KR); Suyoung LEE, Daejeon (KR)

(21) Appl. No.: 18/491,570

(22) Filed: Oct. 20, 2023

(30) Foreign Application Priority Data
Jun. 1, 2023 (KR) 10-2023-0070788

(51) Int. Cl. G06F 18/2415

(52) U.S. Cl. CPC G06F 18/2415; G06N 20/00

(57) ABSTRACT

Disclosed is a random sampling-based collective classification method and system for Sybil account detection. A random sampling-based collective classification method performed by a collective classification system may include performing a first collective classification using training data; constructing sampled new training data by randomly extracting a portion of the entire nodes based on a label assigned to each node according to a result of performing the first collective classification; performing a second collective classification using the constructed new training data; and applying a posterior score difference of each node computed through the first collective classification and the second collective classification to a prior score of each node to be used for training data at a next iteration.

### CROSS-REFERENCE TO RELATED APPLICATION(S)

This application claims the priority benefit of Korean Patent Application No. 10-2023-0070788, filed on Jun. 1, 2023, in the Korean Intellectual Property Office, the disclosure of which is incorporated herein by reference in its entirety.

### BACKGROUND

1. Field of the Invention

The following example embodiments relate to collective classification technology.

### 2. Description of the Related Art

In general, a semi-supervised node classification problem relates to predicting to which a remaining node belongs between a benign node and a Sybil node when some nodes are labeled with a graph structure. A collective classification method refers to an algorithm that is widely used to solve this semi-supervised node classification problem. The collective classification method assigns prior scores of −0.5, 0.5, and 0 to a labeled benign node, a labeled Sybil node, and an unlabeled node, respectively and classifies each node based on a posterior score of each node that is finally calculated through a process of iteratively propagating scores to neighboring nodes.

The collective classification method may be used to detect a Sybil account in a social network. For example, a defender may prepare a graph structure that uses each account of the social network as a node and a following status between accounts as an edge and then may use the collective classification method to infer whether all accounts are malicious, that is, Sybil accounts based on a malicious status of some accounts.

It is known that the existing collective classification method may not accurately detect all Sybil accounts of an attacker in a graph in which an adversarial attack is performed to bypass detection of a specific Sybil account, that is, a target node.

### SUMMARY

Example embodiments may provide an improved collective classification method that may detect a Sybil account at high accuracy despite an adversarial attack.

According to an aspect, there is provided a random sampling-based collective classification performed by a collective classification system, the method including performing a first collective classification using training data: constructing sampled new training data by randomly extracting a portion of the entire nodes based on a label assigned to each node according to a result of performing the first collective classification: performing a second collective classification using the constructed new training data: and applying a posterior score difference of each node computed through the first collective classification and the second collective classification to a prior score of each node to be used for training data at a next iteration.

The performing of the first collective classification may include misclassifying a target node as a benign node based on a posterior score of each node computed through the first collective classification using training data of a defender.

The performing of the first collective classification may include initializing the prior score for each node in the training data of the defender and assigning a fixed prior score to a labeled node.

The performing of the first collective classification may include propagating the posterior score of each node computed through the first collective classification to a neighbor node.

The performing of the second collective classification may include classifying a target node misclassified through the first collective classification as a Sybil node when computing a posterior score through the second collective classification using the new training data.

The performing of the second collective classification may include propagating the posterior score of each node computed through the second collective classification to a neighbor node.

The new training data may be randomly sampled from a plurality of benign nodes and a plurality of Sybil nodes labeled for each node.

The applying may include adjusting a prior score of each target node based on the posterior score difference of each node computed through the first collective classification and the second collective classification at a current iteration, and the adjusted prior score may be applied to a posterior score of a corresponding target node in the training data.

The applying may include applying the posterior score difference to the prior score in the training data at the next iteration and computing a final posterior score using a final prior score derived by completing each iteration.

The applying may include detecting another Sybil node while identifying a target node manipulated by an adversarial attack using the computed final prior score.

According to another aspect, there is provided a non-transitory computer-readable recording medium storing instructions that, when executed by a processor, cause the processor to implement a random sampling-based collective classification method performed by a collective classification system, the random sampling-based collective classification including performing a first collective classification using training data: constructing sampled new training data by randomly extracting a portion of the entire nodes based on a label assigned to each node according to a result of performing the first collective classification: performing a second collective classification using the constructed new training data: and applying a posterior score difference of each node computed through the first collective classification and the second collective classification to a prior score of each node to be used for training data at a next iteration.

According to still another aspect, there is provided a collective classification system including a first classifier configured to perform a first collective classification using training data: a data constructor configured to construct sampled new training data by randomly extracting a portion of the entire nodes based on a label assigned to each node according to a result of performing the first collective classification; a second classifier configured to perform a second collective classification using the constructed new training data: and a prior score assigner configured to apply a posterior score difference of each node computed through the first collective classification and the second collective classification to a prior score of each node to be used for training data at a next iteration.

According to some example embodiments, it is possible to accurately classify a target node as a Sybil node and to improve classification accuracy for all nodes.

A Sybil account in a social network or an online shopping mall may be used for malicious purposes, such as spreading fake news or manipulating product reviews, and greatly degrade trustworthiness of a corresponding service accordingly. According to some example embodiments, it is possible to help quickly detect a Sybil account in various services, such as a social network and an online shopping mall.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a random sampling-based collective classification operation according to an example embodiment:

FIG. 2 is a block diagram illustrating a configuration of a collective classification system according to an example embodiment:

FIG. 3 is a flowchart illustrating a random sampling-based collective classification method according to an example embodiment:

FIG. 4 illustrates an example of a random sampling-based collective classification algorithm according to an example embodiment: and

FIG. 5 illustrates an example of describing a technical effect of a random sampling-based collective classification method according to an example embodiment.

### DETAILED DESCRIPTION

Hereinafter, example embodiments will be described in detail with reference to the accompanying drawings.

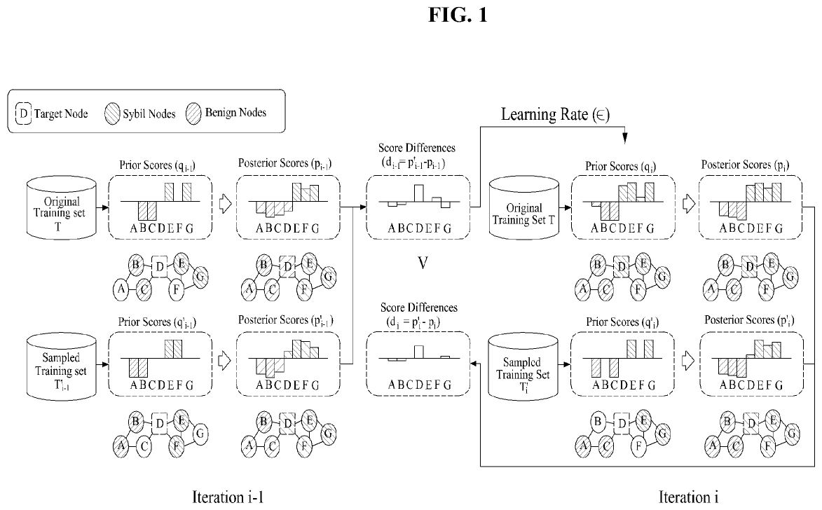

FIG. 1 illustrates a random sampling-based collective classification operation according to an example embodiment.

A graph structure in which all of a benign node and a Sybil node are present is assumed. A situation in which an adversarial attack of modifying the graph structure is performed to bypass detection of a target node is assumed. A defender aims to accurately infer the overall labels in a situation in which labels of some nodes are known. In an example embodiment, a node of which a label the defender knows is referred to as training data.

In a situation in which the adversarial attack is performed, two parties, a victim classifier and an adversary, are assumed. Given a graph G=(V,E), each u∈V corresponds to either a benign node or a Sybil node. Here, the node may belong to one of a positive class and a negative class. The adversary selects a set of target nodes and aims to deceive the victim classifier such that the victim classifier incorrectly classifies the target nodes as benign nodes. For each target node that causes misclassification, a corresponding target node is referred to as an adversarial Sybil node or an adversarial node. The adversary may add a new edge or delete an existing edge. Otherwise, the adversary may generate a new positive node and may connect the positive node to an existing node in a graph.

For example, a graph having a fraudulent social network account is assumed. A node and an edge constituting the graph correspond to a user account and a follower-followee relationship, respectively. In this case, the adversary may select a target account and may make the target account to follow a benign account to bypass a corresponding account detection. Given this manipulated graph G′, the victim classifier tries to identify all Sybil nodes that include the target node.

The adversary, that is, the attacker may manipulate a structure of an underlying graph. This modification requires non-trivial cost, such as creating a new account or following another account. Therefore, the objective of the adversary is to evade detection at minimum cost. If the adversary may afford a larger attack budget, the adversary conducts a stronger attack. The attack budget of the adversary may be controlled using the number of manipulated nodes and edges.

In an example embodiment, a strong adversary is assumed to evaluate the robustness of a collective classification system to the full extent. The adversary knows that the victim classifier performs a collective classification to detect a Sybil node. Also, it is assumed that the adversary knows the following details about the victim classifier. The collective classification system may mitigate threats that this strong adversary poses.

The adversary has prior knowledge regarding parameters, θ and W, used for training the victim classifier. In detail, the adversary knows exact parameters (i.e., prior reputation score θ and weight matrix W).

The victim classifier requires data (set (T)) that includes a series of labeled nodes. When the adversary knows a node used for training, an attack becomes more powerful.

Due to a lack of information, the adversary may be unaware of the complete graph structure (e.g., V and E). For example, for a private account, the adversary may not know followers and may not construct the complete graph. It is assumed that the strong adversary knows the complete graph structure.

The collective classification system may provide an initial collective classification method that aims to identify a target Sybil node manipulated by an adversarial attack while accurately spotting other Sybil nodes. The adversarial attack generally adds an edge between a target node and another node with a considerably different feature and a label. It is reported that this strategy is most effective in achieving the adversarial goal.

The collective classification system may discover that a benign node in training data T corresponds to a node having a notably different feature compared to the target node and a successful adversarial attack necessarily connects its target node to the benign node. A node labeled benign may be assigned with highest negative prior score −θ. Consequently, the benign node is more likely to have a high negative posterior score, effectively propagating a negative score to a node connected to the benign node. Given the adversary's imperative of saving cost by minimizing the number of edges to manipulate, the adversary may certainly add an edge between the benign node and the target node.

The collective classification system may provide a novel random sampling-based collective classification method. The above adversarial attack heavily depends on the training data T. When running the same collective classification algorithm using new (different) training data sampled from the training data T, a prior score of a non-sampled benign node in the (original) training data T becomes zero instead of the highest negative score of −θsince the benign node is not included in the new training data. A large number of benign nodes in the training data T are connected to adversarial nodes. Accordingly, such benign nodes provide fewer negative scores to the adversarial nodes and contribute to correctly identifying the adversarial nodes as positive (i.e., Sybil nodes). That is, using randomly sampled new training data, the collective classification system may compute more reliable posterior scores that render the adversarial attack abusing the benign nodes less effective.

Given the training data T, the collective classification system may be guided to output posterior score close to scores computed from the randomly sampled new training data, robustly performing the collective classification of adversarial Sybil nodes. The collective classification system may search for a set of prior scores for which posterior scores of collective classification do not significantly change when using new training data.

In detail, the collective classification system may gradually change a prior score for each node in a graph such that posterior scores computed based on the training data T show a small difference compared to posterior scores measured using the randomly sampled new training data. Specifically, the collective classification system may iteratively sample new training data, may run a collective classification, and may apply a posterior score difference to a prior score to be assigned in a next iteration.

Referring to FIG. 1, the collective classification system may misclassify a target node D as benign by using posterior scores pᵢ₋₁ computed with training data T at an iteration i−1. However, when computing posterior scores p′ᵢ₋₁ using randomly sampled new training data T′ᵢ₋₁, the collective classification system may correctly classify the target node D as Sybil. The collective classification system may add posterior score differences dᵢ₋₁ to prior scores qᵢ at an iteration i and then may identify the target node D as an adversarial Sybil node using the posterior scores pᵢ. A gap between two posterior scores p and p′ of the target node D becomes narrower over iterations.

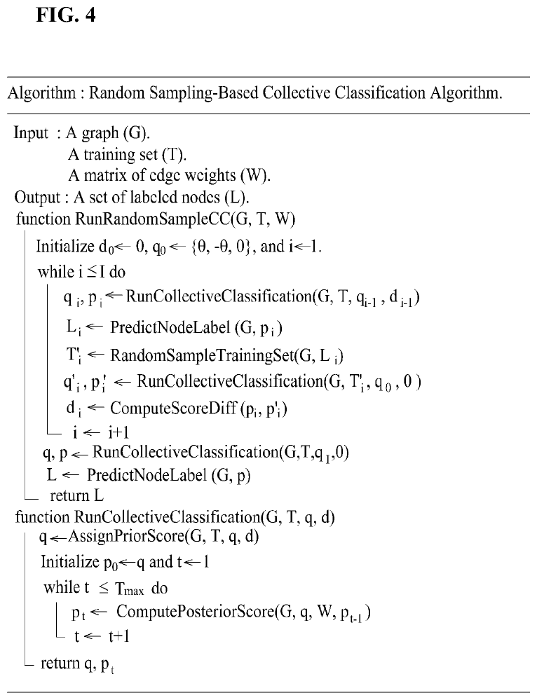

FIG. 4 illustrates an example of a random sampling-based collective classification algorithm. The collective classification system may use the following four configurable parameters.

A learning rate ( [symbol] ): This learning rate parameter controls a step size when applying, that is, incorporating a posterior score into a next prior score.

The number of sampled nodes (N): The collective classification system randomly samples N benign nodes and N Sybil nodes and compares posterior scores computed with the sampled new training data T′ and the training data T.

A buffer ratio (ρ): The collective classification system depends on this buffer ratio parameter and provides a buffer zone that may adjust a subtle effect of slightly fluctuating posterior scores.

A maximum number of iterations (I): In each iteration, the collective classification system gradually moves posterior scores computed from the training data T toward scores computed with the new training data T′.

A RunRandomSampleCC function uses a graph G, a training set T, a weight matrix W, and four configurable parameters from a user. At each iteration i, the function starts by running the collective classification algorithm using the training data T to compute the posterior scores pᵢ(line 4). Based on the posterior scores pi, the collective classification system labels each node in the graph and randomly samples the same number of benign nodes and Sybil nodes from a labeled set Lᵢ(lines 5 and 6). The collective classification system computes posterior score data p′ᵢ(line 7) using a sampled node as new training data T_{i.}

Then, the collective classification system computes a difference between two posterior scores pᵢ and p′ᵢ(line 8) through a ComputeScoreDiff function. The difference between two posterior scores may be applied to prior scores qi+1 at a next iteration (line 14 invoked by line 4). After I times of iterations, the collective classification system runs the collective classification algorithm using final prior scores q_{I} to detect Sybil nodes (lines 10 and 11).

When assigning prior scores using the training data T, the collective classification system may accumulate posterior score differences over iterations through an AssignPriorScore function as shown in the following Equation 1.

$${q}_{u , i} = \{ \begin{matrix}θ & u ∈ {L}_{P} \\ - θ & u ∈ {L}_{N} \\ {q}_{u , i - 1} \cdot {d}_{u , i - 1} & otherwise\end{matrix} , \qquad Equation 1$$

In Equation 1, q_{u,i} and d_{u,i} correspond to a prior score difference and a posterior score difference of node u at the iteration i, respectively. The AssignPriorScore function assigns a fixed prior score (i.e., θor −θ) to a labeled node in the training data T. For the randomly sampled new training data T′, the collective classification system may assign prior scores using Equation 2.

$${q}_{u} = \{ \begin{matrix}θ & u ∈ {L}_{P} \\ - θ & u ∈ {L}_{N} \\ 0 & otherwise\end{matrix} , \qquad Equation 2$$

In Equation 2, Lₚ denotes a set of known positive (i.e., Sybil) nodes, L_{N} denotes a set of known negative (i.e., benign) nodes, and θ(θ>0) denotes a positive prior score for a Sybil node.

The collective classification system may iteratively propagate a posterior score of each node to a neighbor node through a ComputePosteriorScore function. Here, when slightly adjusting the prior score of each target node based on posterior score differences computed through several exploratory experiments, the impact of such adjustment may be aggregated across all target nodes and directly added to posterior scores of benign nodes in the training data T. Considering that such nodes are highly interconnected, this may cause the overall posterior score of benign nodes and target nodes to fluctuate over iterations.

$${p}_{t} = ρ ( {q}_{i} + 2 {Wp}_{t - 1} ) \qquad Equation 3$$

As shown in Equation 3, the ComputePosteriorScore function may be designed to scale down the impact of posterior scores aggregated from connected neighbor nodes by multiplying the scores by buffer ratio when aggregating the posterior scores. Here, the buffer ratio may be empirically selected to be 0.8. After I times of iterations, the collective classification system may compute the final posterior scores without the buffer ratio using the optimized prior scores q_{I}.

It is emphasized that the existing collective classification algorithm assigns a fixed prior score (i.e., θor−θ) to a labeled node and assigns a prior score of zero to an unlabeled node. Since the adversary is aware that the collective classification algorithm assigns the prior score in this manner, the adversary adapts an attack using initial prior score data. Therefore, instead of assigning prior scores of zero to unlabeled nodes, prior scores of the unlabeled node may be gradually adjusted using the randomly sampled new training data such that the computed posterior scores become robust to such adversarial attacks.

Although the collective classification system requires new training data at each iteration, new training data may be sampled using prediction made at a previous iteration. Therefore, additional labeling effort for robust Sybil detection is not required. In addition, unless the adversary compromises the graph so aggressively that even using the randomly sampled new training data yields a high negative posterior score for target nodes, the collective classification system may still perform robust detection. Also, the collective classification system and method proposed in an example embodiment are compatible with any collective classification algorithms and thus readily applicable to existing collective classification services.

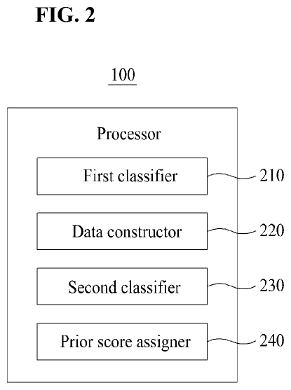

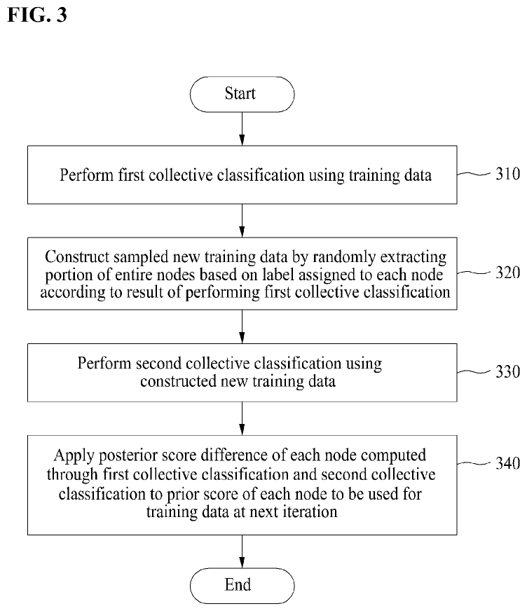

FIG. 2 is a block diagram illustrating a configuration of a collective classification system according to an example embodiment and FIG. 3 is a flowchart illustrating a random sampling-based collective classification method according to an example embodiment.

A processor of a collective classification system 100 may include a first classifier 210, a data constructor 220, a second classifier 230, and a prior score assigner 240. The components of the processor may be representations of different functions performed by the processor in response to a control instruction provided from a program code stored in the collective classification system. The processor and the components of the processor may control the collective classification system to perform operations 310 to 340 included in the random sampling-based collective classification method of FIG. 3. Here, the processor and the components of the processor may be configured to execute an instruction according to a code of at least one program and a code of an OS included in a memory.

The processor may load, to the memory, a program code stored in a file of a program for the random sampling-based collective classification method. For example, when the program runs on the collective classification system, the processor may control the collective classification system to load the program code from the file of the program to the memory under control of the OS. Here, the first classifier 210, the data constructor 220, the second classifier 230, and the prior score assigner 240 may be different functional representations of the processor for executing an instruction of a part corresponding to the program code loaded to the memory.

In operation 310, the first classifier 210 may perform a first collective classification using training data. The first classifier 210 may misclassify a target node as a benign node based on a posterior score of each node computed through the first collective classification using training data of a defender. The first classifier 210 may initialize the prior score for each node in the training data of the defender and may assign a fixed prior score to a labeled node. The first classifier 210 may propagate the posterior score of each node computed through the first collective classification to a neighbor node.

In operation 320, the data constructor 220 may construct sampled new training data by randomly extracting a portion of the entire nodes based on a label assigned to each node according to a result of performing the first collective classification.

In operation 330, the second classifier 230 may perform a second collective classification using the constructed new training data. The second classifier 230 may classify a target node misclassified through the first collective classification as a Sybil node when computing a posterior score through the second collective classification using the new training data. The second classifier 230 may propagate the posterior score of each node computed through the second collective classification to a neighbor node.

In operation 340, the prior score assigner 240 may apply a posterior score difference of each node computed through the first collective classification and the second collective classification to a prior score of each node to be used for training data at a next iteration. The prior score assigner 240 may adjust a prior score of each target node based on the posterior score difference of each node computed through the first collective classification and the second collective classification at a current iteration. Here, the adjusted prior score may be applied to a posterior score of a corresponding target node in the training data. The prior score assigner 240 may apply the posterior score difference to the prior score in the training data at the next iteration and may compute a final posterior score using a final prior score derived by completing each iteration. The prior score assigner 240 may detect another Sybil node while identifying a target node manipulated by an adversarial attack using the computed final prior score.

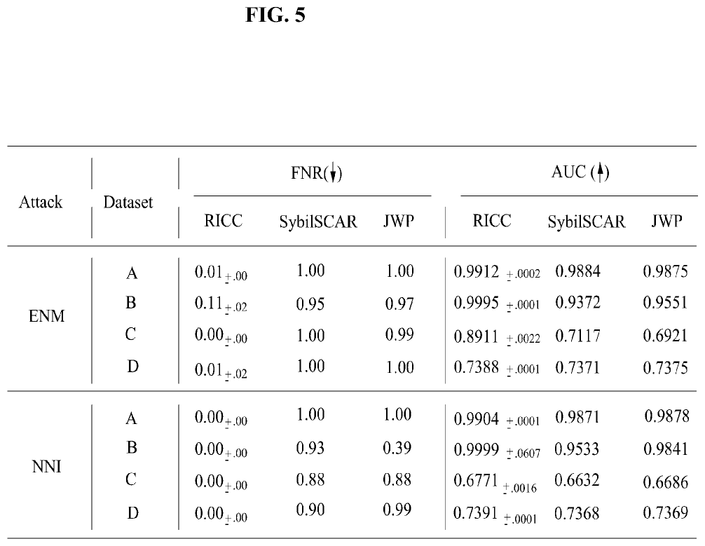

FIG. 5 illustrates the technical effect of a random sampling-based collective classification method according to an example embodiment.

A collective classification system according to an example embodiment may provide a first collective classification framework that may robustly detect a Sybil node. The collective classification system uses the novel observation that posterior scores of Sybil nodes generated by adversarial attacks are highly volatile with respect to initial data of prior scores. Therefore, the collective classification system learns a robust method for performing a collective classification in which posterior scores remain steady across a plurality of pieces of data of prior scores randomly sampled from original training data.

Our experimental results demonstrate that the proposed method outperforms all the existing Sybil node detection methods in identifying a Sybil node, including an adversarial node, thus, representing that the proposed method is established as a first practical tool for performing a robust Sybil node identification.

FIG. 5 shows the experimental results actually performed from data sets, such as Enron, Facebook, Twitter, and the like. Here, Robust Inhibitor of differences in Collective Classification (RICC) represents the method proposed in the example embodiment, and SybilSCAR and JWP represent existing collective classification methods, and ENM and NNI represent two adversarial attacks. FNR is an indicator that shows the number of nodes that are misclassified as benign nodes among 100 target nodes. The lower a value of FNR, the more successful a defense method is. Also, AUC is an indicator that shows an accuracy level of the defense method for the entire nodes. The method proposed in the example embodiment may accurately classify target nodes as Sybil nodes and may also improve classification accuracy for the entire nodes.

The apparatuses described herein may be implemented using hardware components, software components, and/or combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non- transitory computer-readable media including program instructions to implement various operations embodied by a computer. Also, the media may include, alone or in combination with the program instructions, data files, data structures, and the like. Program instructions stored in the media may be those specially designed and constructed for the purposes, or they may be of the kind well-known and available to those having skill in the computer software arts. Examples of non-transitory computer-readable media include magnetic media such as hard disks, floppy disks, and magnetic tape: optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter.

While this disclosure includes specific example embodiments, it will be apparent to one of ordinary skill in the art that various alterations and modifications in form and details 5 may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, the scope of the 10 disclosure is defined not by the detailed description, but by the claims and their equivalents, and all variations within the scope of the claims and their equivalents are to be construed as being included in the disclosure.

What is claimed is:

1. A random sampling-based collective classification method performed by a collective classification system, the method comprising:
performing a first collective classification using training data;
constructing sampled new training data by randomly extracting a portion of the entire nodes based on a label assigned to each node according to a result of performing the first collective classification;
performing a second collective classification using the constructed new training data; and
applying a posterior score difference of each node computed through the first collective classification and the second collective classification to a prior score of each node to be used for training data at a next iteration.

2. The method of claim 1, wherein the performing of the first collective classification comprises misclassifying a target node as a benign node based on a posterior score of each node computed through the first collective classification using training data of a defender.

3. The method of claim 2, wherein the performing of the first collective classification comprises initializing the prior score for each node in the training data of the defender and assigning a fixed prior score to a labeled node.

4. The method of claim 2, wherein the performing of the first collective classification comprises propagating the posterior score of each node computed through the first collective classification to a neighbor node.

5. The method of claim 1, wherein the performing of the second collective classification comprises classifying a target node misclassified through the first collective classification as a Sybil node when computing a posterior score through the second collective classification using the new training data.

6. The method of claim 5, wherein the performing of the second collective classification comprises propagating the posterior score of each node computed through the second collective classification to a neighbor node.

7. The method of claim 1, wherein the new training data is randomly sampled from a plurality of benign nodes and a plurality of Sybil nodes labeled for each node.

8. The method of claim 1, wherein the applying comprises adjusting a prior score of each target node based on the posterior score difference of each node computed through the first collective classification and the second collective classification at a current iteration, and
the adjusted prior score is applied to a posterior score of a corresponding target node in the training data.

9. The method of claim 1, wherein the applying comprises applying the posterior score difference to the prior score in the training data at the next iteration and computing a final posterior score using a final prior score derived by completing each iteration.

10. The method of claim 9, wherein the applying comprises detecting another Sybil node while identifying a target node manipulated by an adversarial attack using the computed final prior score.

11. A non-transitory computer-readable recording medium storing instructions that, when executed by a processor, cause the processor to implement a random sampling- based collective classification method performed by a collective classification system, the random sampling-based collective classification comprising:
performing a first collective classification using training data;
constructing sampled new training data by randomly extracting a portion of the entire nodes based on a label assigned to each node according to a result of performing the first collective classification;
performing a second collective classification using the constructed new training data; and
applying a posterior score difference of each node computed through the first collective classification and the second collective classification to a prior score of each node to be used for training data at a next iteration.

12. A collective classification system comprising:
a first classifier configured to perform a first collective classification using training data;
a data constructor configured to construct sampled new training data by randomly extracting a portion of the entire nodes based on a label assigned to each node according to a result of performing the first collective classification;
a second classifier configured to perform a second collective classification using the constructed new training data; and
a prior score assigner configured to apply a posterior score difference of each node computed through the first collective classification and the second collective classification to a prior score of each node to be used for training data at a next iteration.

13. The collective classification system of claim 12, wherein the first classifier is configured to misclassify a target node as a benign node based on a posterior score of each node computed through the first collective classification using training data of a defender.

14. The collective classification system of claim 13, wherein the first classifier is configured to initialize the prior score for each node in the training data of the defender and to assign a fixed prior score to a labeled node.

15. The collective classification system of claim 13, wherein the first classifier is configured to propagate the posterior score of each node computed through the first collective classification to a neighbor node.

16. The collective classification system of claim 12, wherein the second classifier is configured to classify a target node misclassified through the first collective classification as a Sybil node when computing a posterior score through the second collective classification using the new training data.

17. The collective classification system of claim 16, wherein the second classifier is configured to propagate the posterior score of each node computed through the second collective classification to a neighbor node.

18. The collective classification system of claim 12, wherein the prior score assigner is configured to adjust a prior score of each target node based on the posterior score difference of each node computed through the first collective classification and the second collective classification at a current iteration, and the adjusted prior score is applied to a posterior score of a corresponding target node in the training data.

19. The collective classification system of claim 12, wherein the prior score assigner is configured to apply the posterior score difference to the prior score in the training data at the next iteration and to compute a final posterior score using a final prior score derived by completing each iteration.

20. The collective classification system of claim 19, wherein the prior score assigner is configured to detect another Sybil node while identifying a target node manipulated by an adversarial attack using the computed final prior score.
